(19) United States
(12) Patent Application Publication
(10) Pub. No.: US 2015/0085313 A1
(43) Pub. Date: Mar. 26, 2015

(54) INFORMATION PROCESSING APPARATUS AND METHOD FOR CONTROLLING THE SAME

(71) Applicant: CANON KABUSHIKI KAISHA, Tokyo (JP)

(72) Inventor: Minoru Hashimoto, Chigasaki-shi (JP)

(21) Appl. No.: 14/493,787

(22) Filed: Sep. 23, 2014

(30) Foreign Application Priority Data
Sep. 26, 2013 (JP) 2013-200060

(51) Int. Cl. H04N 1/00

(52) U.S. Cl. CPC H04N 1/00891; H04N 2201/0094
USPC 358/1.14

(57) ABSTRACT

An information processing apparatus includes a first control unit, a detection unit configured to detect a person, a generation unit configured to, when a person is detected by the detection unit, generate power to be supplied to the control unit, a determination unit configured to determine whether the person detected by the detection unit is a user of the information processing apparatus, and a second control unit configured to, when the determination unit determines that the person detected by the detection unit is a user of the information processing apparatus, perform control to supply the power generated by the generation unit to the first control unit.

### BACKGROUND OF THE INVENTION

1. Field of the Invention

One disclosed aspect of the embodiments relates to an information processing apparatus for controlling a power state, and a method for controlling the information processing apparatus.

2. Description of the Related Art

An image forming apparatus having a print function, a scanning function, and a fax function, such as a multifunction peripheral (MFP) or a printer, is provided with an energy-saving mode for reducing power consumption when the apparatus is not in use. For example, a certain image forming apparatus mounts a human body detection sensor to improve user's convenience when returning from the energy-saving mode. This type of image forming apparatus has advantages that user's button operations can be omitted, and that the apparatus can return from the energy-saving mode quicker than with button operations. However, since there is a possibility to incorrectly detect a person who does not intend to operate the image forming apparatus, it is necessary to reduce the possibility of false detection.

As a first example, Japanese Patent Application Laid-Open No. 2006-313407 discusses an image forming apparatus which, to reduce the possibility of false detection, first detects a human body (moving object) and monitors the motion of the detected human body. Then, if the image forming apparatus has kept human body detection for a predetermined time period, it determines that a user has approached the apparatus, and returns from the energy-saving mode.

As a second example, a certain image forming apparatus detects a human body by using a low-accuracy pyroelectric sensor providing low power consumption. After the detection of a human body, the image forming apparatus turns ON the power of a reflection type sensor capable of high-accuracy human body detection with high power consumption, and, at the timing when the possibility of false detection becomes low, determines that a user has approached the apparatus.

Although both of the above-described examples are effective in reducing the possibility of false detection, they have a problem that detection takes time. This problem is disadvantageous in shortening the return time which is one of advantages of using the human body detection method.

The second example has a problem that, in the case of false detection, the reflection type sensor providing high power consumption uselessly consumes power.

### SUMMARY OF THE INVENTION

A disclosed aspect of the embodiments is directed to providing a mechanism for restricting power generation processing in a case where, even after power generation starts upon detection of a factor to lead a second power state to be canceled, the factor to lead the second power state to be canceled is not maintained.

According to an aspect of the embodiments, an information processing apparatus includes a first control unit, a first detection unit configured to detect a person, a generation unit configured to generate power to be supplied to the control unit when a person is detected by the first detection unit, a determination unit configured to determine whether the person detected by the first detection unit is a user of the information processing apparatus, and a second control unit configured to, when the determination unit determines that the person detected by the first detection unit is a user of the information processing apparatus, perform control to supply the power generated by the generation unit to the first control unit.

Further features of the disclosure will become apparent from the following description of exemplary embodiments with reference to the attached drawings.

### BRIEF DESCRIPTION OF THE DRAWINGS

FIG. 1 illustrates a configuration of an example system including an image forming apparatus.

FIG. 2 is a block diagram illustrating an internal configuration of an MFP illustrated in FIG. 1.

FIG. 3 illustrates a range of human body detection by the MFP, and a position of a human body.

FIG. 4 is a block diagram illustrating an internal structure of a human body detection unit illustrated in FIG. 2.

FIG. 5 is a block diagram illustrating a configuration of a control unit illustrated in FIG. 2.

FIG. 6 is a block diagram illustrating a configuration of a local power source unit.

FIG. 7 is a block diagram illustrating a configuration of a switch unit illustrated in FIG. 5.

FIG. 8 is a timing chart illustrating an example operation of the switch unit illustrated in FIG. 7.

FIG. 9 is a timing chart illustrating power outputs and control signals.

FIG. 10 is a flowchart illustrating a method for controlling the image forming apparatus.

FIG. 11 is a block diagram illustrating a configuration of the image forming apparatus.

FIG. 12 is a timing chart illustrating operations of the image forming apparatus illustrated in FIG. 11.

### DESCRIPTION OF THE EMBODIMENTS

Various exemplary embodiments, features, and aspects of the disclosure will be described in detail below with reference to the drawings.

An image forming apparatus according to a first exemplary embodiment starts power supply in advance during a wait time for false detection prevention to quickly return from an energy-saving mode.

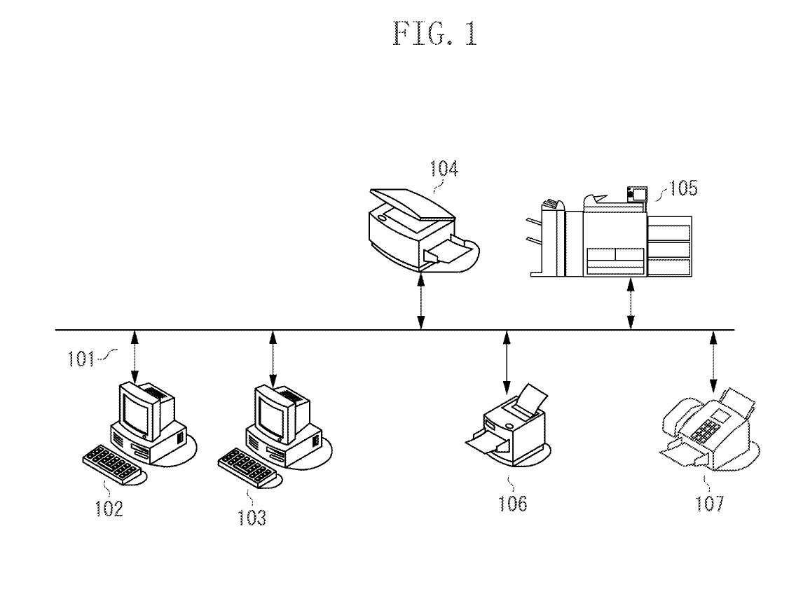

FIG. 1 is a configuration of an example system including an image forming apparatus according to the present exemplary embodiment.

Referring to FIG. 1, MFPs 104 and 105, a printer 106, and a fax 107 are connected to a network 101. In this case, Ethernet (registered trademark) is used as the network 101. The image forming apparatus according to the present exemplary embodiment is provided with a function of performing power control in a first power state and in a second power state in which the apparatus provides lower power consumption than in a first power state.

Since the disclosure is not dependent on a network format, it is also applicable to other network systems. The MFPs 104 and 105 are devices having copy, printer, and scanner functions in an integrated way. There are variations in color printing and printing speed. The printer 106 and the fax 107 are single-function apparatuses. Personal computers (PCs) 102 and 103 are user's PCs capable of performing printing operations, scanning operations, and fax transmitting operations by transmitting/receiving data to/from the MFPs 104 and 105, the printer 106, and the fax 107 connected to the network 101.

The configuration and operations of the MFP 104 will be described below. Although the embodiment is also applicable to the MFP 105, the printer 106, and the fax 107, it will be described below based on the MFP 104 to simplify descriptions.

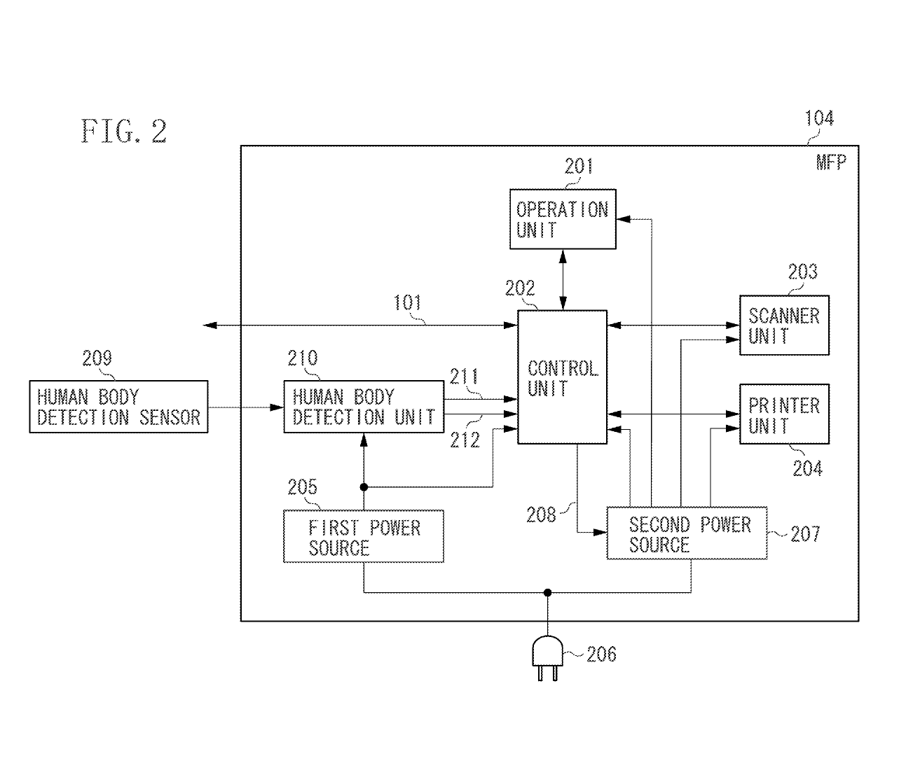

FIG. 2 is a block diagram illustrating an internal configuration of the MFP 104 illustrated in FIG. 1.

Referring to FIG. 2, a control unit 202 controls operations of the MFP 104 to perform data transmission and reception, data conversion, data storage, and power control. When the MFP 104 performs print operations, job data is generated by the PC 102, transmitted to the control unit 202 via the network 101, and then once stored in the control unit 202. The control unit 202 converts the stored job data into image data, and transmits it to a printer unit 204. The printer unit 204, under control of the control unit 202, prints the image data on recording paper (sheet) and discharges it to the outside of the apparatus.

When the MFP 104 performs scanning operations, the user sets a document onto a scanner unit 203, performs button operations referring to a screen of an operation unit 201 to set scanning operations, and instructs to start scanning operations. The scanner unit 203, under control of the control unit 202, optically reads the document, and converts it into image data. The image data is once stored in the control unit 202. Then, the control unit 202 transmits the image data to a transmission destination specified from the operation unit 201 in advance.

When the MFP 104 performs copy operations, the user sets a document onto the scanner unit 203, performs button operations referring to the screen of the operation unit 201 to set copy operations, and instructs to start copy operations. The scanner unit 203, under control of the control unit 202, optically reads the document, and converts it into image data. The image data is once stored in the control unit 202. Then, the control unit 202 converts the image data into a data format usable by the printer unit 204. The printer unit 204 prints the image data on a sheet, and discharges it to the outside of the apparatus.

A first power source 205 and a second power source 207 function as a power source unit for converting alternating-current (AC) commercial power supplied from a power plug 206 into a direct-current (DC) voltage to be used by each unit of the MFP 104. The second power source 207 is subjected to power output control by a power source control signal 208 output from the control unit 202.

In a normal mode (a mode of the first power state) for performing image formation processing, the first power source 205 is turned ON. In the energy-saving mode (a mode of the second power state) in which the apparatus provides lower power consumption than in the first power state, the first power source 205 is turned OFF.

The energy-saving mode is a mode in which, while the apparatus does not performing job processing, power supply to portions other than the control unit 202 stops to reduce the power consumption of commercial power. In the energy-saving mode, the control unit 202 can detect job reception, and a human body detection unit 210 can detect a human body based on an output signal from a human body detection sensor 209. In a state where there is a possibility of false detection, the human body detection unit 210 asserts a signal indicating human body detection. Then, power supply to each circuit starts.

The control unit 202 includes a switch unit on a power line. Turning OFF the switch unit interrupts power supply to each circuit of the control unit 202. Although the power consumption slightly increases by starting power supply under a no-load condition, the power consumption is very small in comparison with that during a normal operation. When a human body detection state continues for a predetermined time period, the human body detection unit 210 asserts a human body detection return trigger signal 212, and turns ON the switch unit in the control unit 202 to start power supply to each circuit. In a case of false detection, by negating a human body detection signal 211 in a state where the human body detection return trigger signal 212 is not asserted, the power consumption in a normal energy-saving mode can be immediately restored. If power supply is turned ON to activate each circuit of the control unit 202 at the time of false detection, the control unit 202 needs to reliably perform activation processing and shutdown processing. As a result, the control unit 202 will continue a high power consumption state for a prolonged time period.

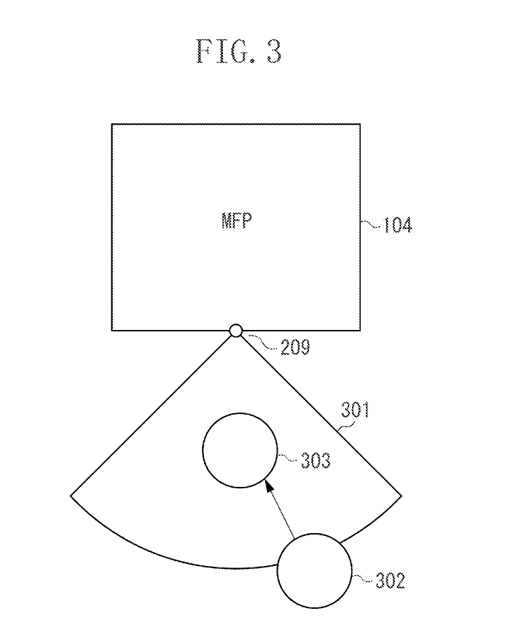

FIG. 3 illustrates a range of human body detection by the MFP 104, and the position of a human body.

In the present exemplary embodiment, the human body detection sensor 209 is provided on a front face of the MFP 104. Since the human body detection sensor 209 is a pyroelectric sensor, the human body can be detected in a certain amount of width and distance, as indicated by a human body detection area 301.

When the human body exists at a first position 302, the human body detection unit 210 asserts the human body detection signal 211. Then, the human body detection unit 210 maintains the human body detection state until the human body moves to a second position 303 after a predetermined time period has elapsed. At this timing, the human body detection unit 210 asserts the human body detection return trigger signal 212 illustrated in FIG. 2. To reduce the possibility of false detection, it is necessary to wait for a predetermined time period.

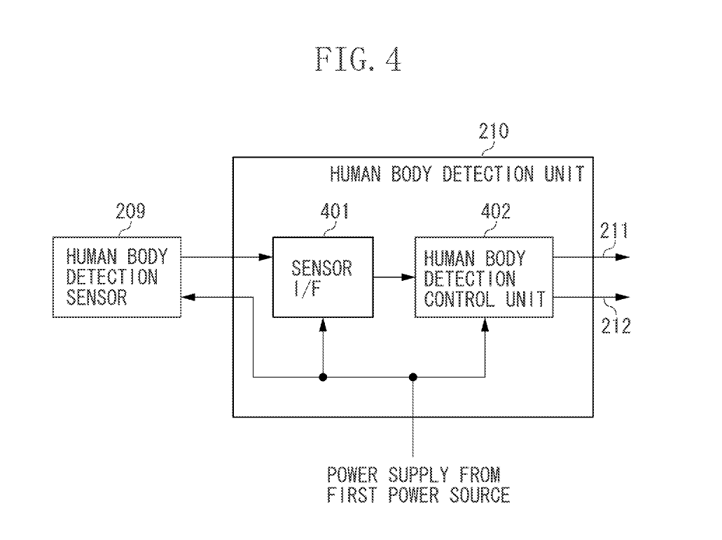

FIG. 4 is a block diagram illustrating an internal structure of the human body detection unit 210 illustrated in FIG. 2.

Referring to FIG. 4, the human body detection unit 210 performs signal level amplification and filtering for noise elimination on an output signal of the human body detection sensor 209 by using a sensor I/F 401, and outputs the signal to a human body detection control unit 402. The human body detection control unit 402 determines the human body detection state based on a signal input from the sensor I/F 401. When the human body detection control unit 402 recognizes the human body detection state, it asserts the human body detection signal 211.

To determine whether the human body is a passer-by or a person (operator) who intends to operate the MFP 104, the human body detection control unit 402 checks whether the human body detection is to be continued for a predetermined time period by using a timer. When a predetermined time period has elapsed since a human body was first detected, the human body detection control unit 402 asserts the human body detection return trigger signal 212.

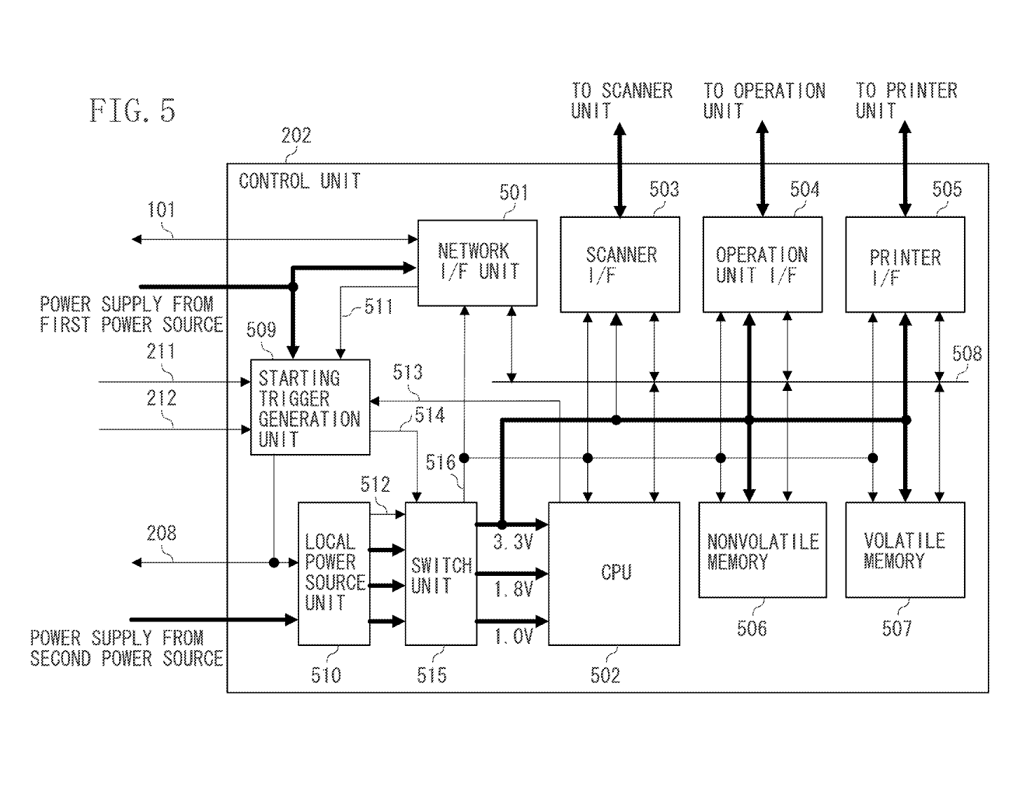

FIG. 5 is a block diagram illustrating a configuration of the control unit 202 illustrated in FIG. 2.

Referring to FIG. 5, a central processing unit (CPU) 502 for controlling the control unit 202 reads a program from a low-speed nonvolatile memory 506, writes the program to a high-speed volatile memory 507, and executes the program on the volatile memory 507. The volatile memory 507 is used also as a temporarily storage area. A network I/F unit 501 for performing network communication, a scanner I/F 503 for communicating with the scanner unit 203, and a printer I/F 505 for communicating with the printer unit 204 are connected each other via an internal bus 508. An operation unit I/F 504 performs input/output processing between the operation unit 201 and the CPU 502.

When the MFP 104 is in the energy-saving mode, the output of the second power source 207 is turned OFF by the power source control signal 208 output from the control unit 202. At this timing, only the network I/F unit 501 and a starting trigger generation unit 509 are operating in the control unit 202 since they receives power supply from the first power source 205.

One shift trigger for shifting from the energy-saving mode to the normal state is reception of a wake packet via the network 101. The network I/F unit 501 refers to the contents of a received packet, and, when it determines that the packet needs to be processed, such as job data, it asserts a network return trigger signal 511. Another shift trigger for shifting from the energy-saving mode to the normal state is detection by the human body detection unit 210 that a user has approached the MFP 104 to operate it.

When the human body detection signal 211 is asserted, the starting trigger generation unit 509 asserts the power source control signal 208 for activating the second power source 207. At this timing, the second power source 207 starts outputting 12 V, and the local power source unit 510 for generating power having different power potential levels starts outputting 3.3 V, 1.8 V, and 1.0 V. However, while the human body detection return trigger signal 212 is in a negate state, the outputs of the local power source unit 510 are interrupted by a switch unit 515. Therefore, since power is not supplied to each circuit, none of circuits is activated. When the human body detection return trigger signal 212 is asserted, the starting trigger generation unit 509 asserts an operation control signal 514. When the operation control signal 514 is input to the switch unit 515, the switch unit 514 changes to the connecting state to start power supply to each circuit of the control unit 202, and negates a second reset signal 516. Then, the circuits of the control unit 202 start operating. A first reset signal 512 is input to the switch unit 515 from the local power source unit 510. The first reset signal 512 will be described below.

When no print, copy, or fax job is executed, and no user operation is performed on the operation unit 201 in the normal mode, the CPU 502 shifts to the energy-saving mode. To shift to the energy-saving mode, the CPU 502 performs processing for shutting down the operating system (OS) and processing for deactivating each unit, and then controls the power source control signal 208 to turn OFF the second power source 207.

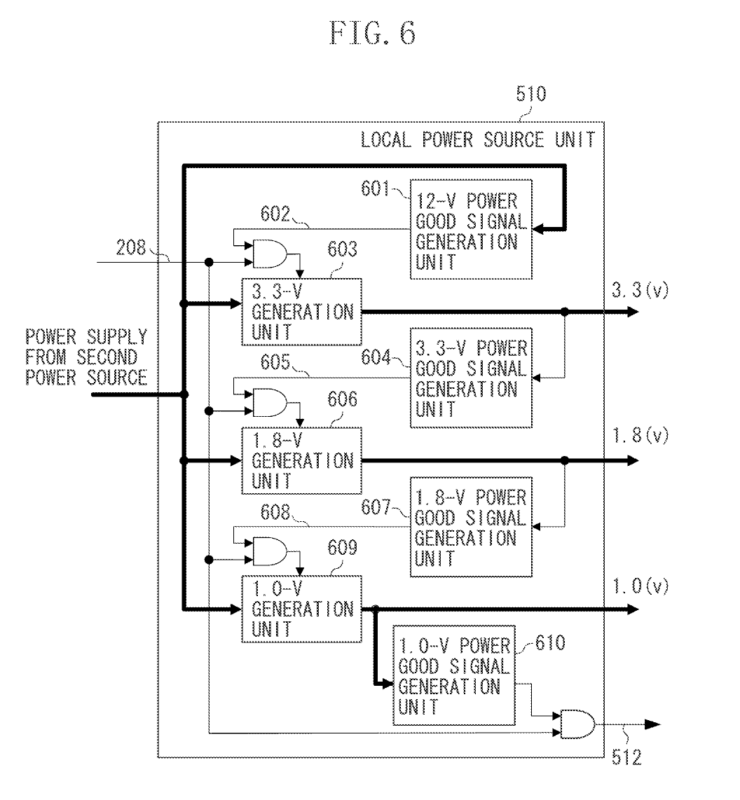

FIG. 6 is a block diagram illustrating a configuration of the local power source unit 510 in a conventional case.

Referring to FIG. 6, the local power source unit 510 outputs three different power voltages (3.3 V, 1.8 V, and 1.0 V) from the 12-V power output from the second power source 207, and outputs the first reset signal 512 indicating that these three power outputs are stable.

A 12-V power good signal generation unit 601 for generating 12 Volts of direct current (VDC) is a circuit for detecting whether 12-V power from the second power source 207 reaches a prescribed value or higher. When 12-V power reaches the prescribed value or higher, the 12-V power good signal generation unit 601 asserts a 12-V power good signal 602. Regularly, a delay time is provided before asserting the power good signal 602 in consideration of a time duration until the signal becomes stable. The 12-V power good signal 602 is ANDed (logical product) with the power source control signal 208. The resultant output is input to the enable terminal of a 3.3-V generation unit 603. When starting power supply, the local power source unit 510 activates the 3.3-V generation unit 603 after the 12-VDC output of the second power source 207 becomes stable.

When turning power OFF, the starting trigger generation unit 509 illustrated in FIG. 5 immediately negates the power source control signal 208, and the output of the 3.3-V generation unit 603 is turned OFF. When starting power supply, power supply sequentially starts with a margin by using a delay circuit to achieve stable operations. When turning power supply OFF, power supply to all circuits is simultaneously turned OFF to prevent degradation of the circuit reliability. However, it is necessary to perform timing design within a range in which specifications of semiconductor devices used in the control unit 202 are satisfied.

A 3.3-V power good signal generation unit 604 is a circuit for monitoring the output voltage of the 3.3-V generation unit 603. When starting power supply, the 3.3-V power good signal generation unit 604 asserts a 3.3-V power good signal 605 after providing a predetermined delay time, similar to the 12-V power good signal generation unit 601. The power good signal 605 asserted by the 3.3-V power good signal generation unit 604 activates a 1.8-V generation unit 606. Likewise, a power good signal 608 asserted by a 1.8-V power good signal generation unit 607 activates a 1.0-V generation unit 609. A 1.0-V power good generation unit 610 monitors the output voltage of the 1.0-V generation unit 609. The output voltage of the 1.0-V power good generation unit 610 is ANDed with the power source control signal 208. The resultant output, as the first reset signal 512, is connected to each circuit of the control unit 202.

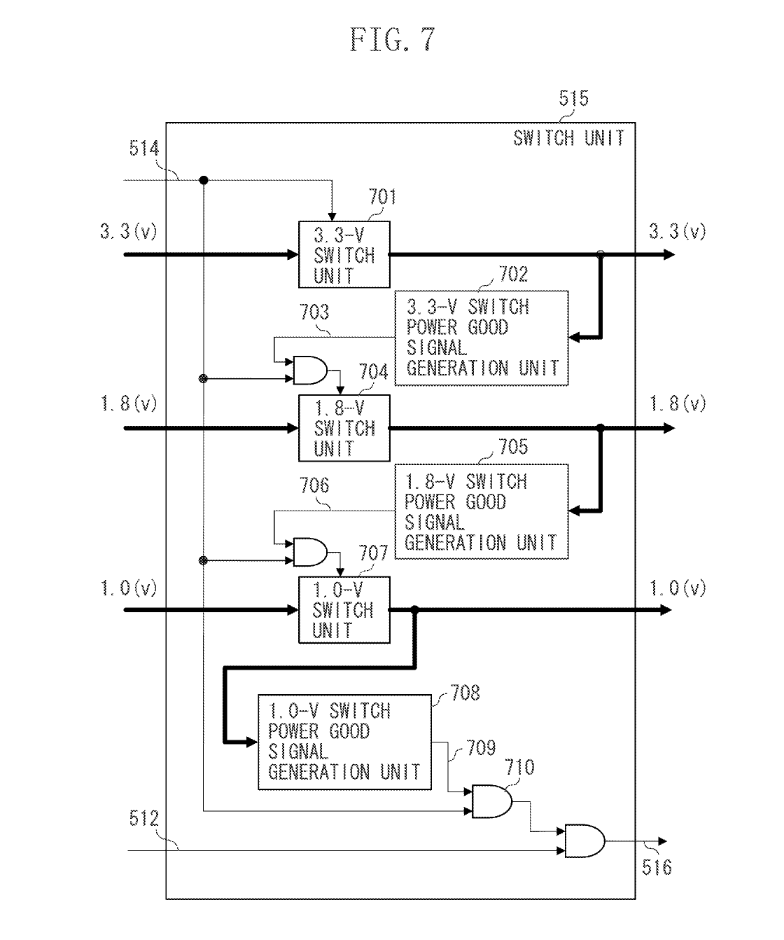

FIG. 7 is a block diagram illustrating a configuration of the switch unit 515 illustrated in FIG. 5.

Referring to FIG. 7, 3.3-V power, 1.8-V power, and 1.0-V power output from the local power source unit 510 are input to a 3.3-V switch unit 701, a 1.8-V switch unit 704, and a 1.0-V switch unit 707, respectively. Outputs of these switch units are supplied to other circuits.

When the operation control signal 514 is asserted, the 3.3-V switch unit 701 is first connected. The output of the 3.3-V switch unit 701 is supplied to other circuits of the control unit 202, and input to a 3.3-V switch power good signal generation unit 702. When the output of the 3.3-V switch unit 701 is equal to or higher than a prescribed voltage, a 3.3-V switch power good signal 703 is asserted and the 1.8-V switch unit 704 is connected.

Likewise, the output voltage of the 1.8-V switch unit 704 enables a 1.8-V switch power good signal generation unit 705 to generate a 1.8-V switch power good signal 706. Then, the 1.0-V switch unit 707 is connected. The output voltage of the 1.0-V switch unit 707 enables a 1.0-V switch power good signal generation unit 708 to generate a 1.0-V switch power good signal 709. The power good signal for each switch unit is ANDed with the operation control signal 514. Therefore, when the operation control signal 514 is negated, power supply to all circuits is turned OFF, and the reset signal is asserted.

The power good signal 709 of the 1.0-V switch power good signal generation unit 708 is ANDed with the operation control signal 514. The resultant, i.e., an internal reset signal 710 is further ANDed with the first reset signal 512. The resultant is connected, as the second reset signal 516, to each circuit of the control unit 202.

This configuration is used when the negation of the internal reset signal 709 is earlier than the negation of the first reset signal 512. In this case, any one voltage of the local power source unit 510 is not output, or the delay time of the first reset signal 512 has not yet elapsed. Since the second reset signal 516 is negated simultaneously with or after the first reset signal 512, the internal reset signal 710 and the first reset signal 512 are output as the second reset signal 516 via an AND circuit.

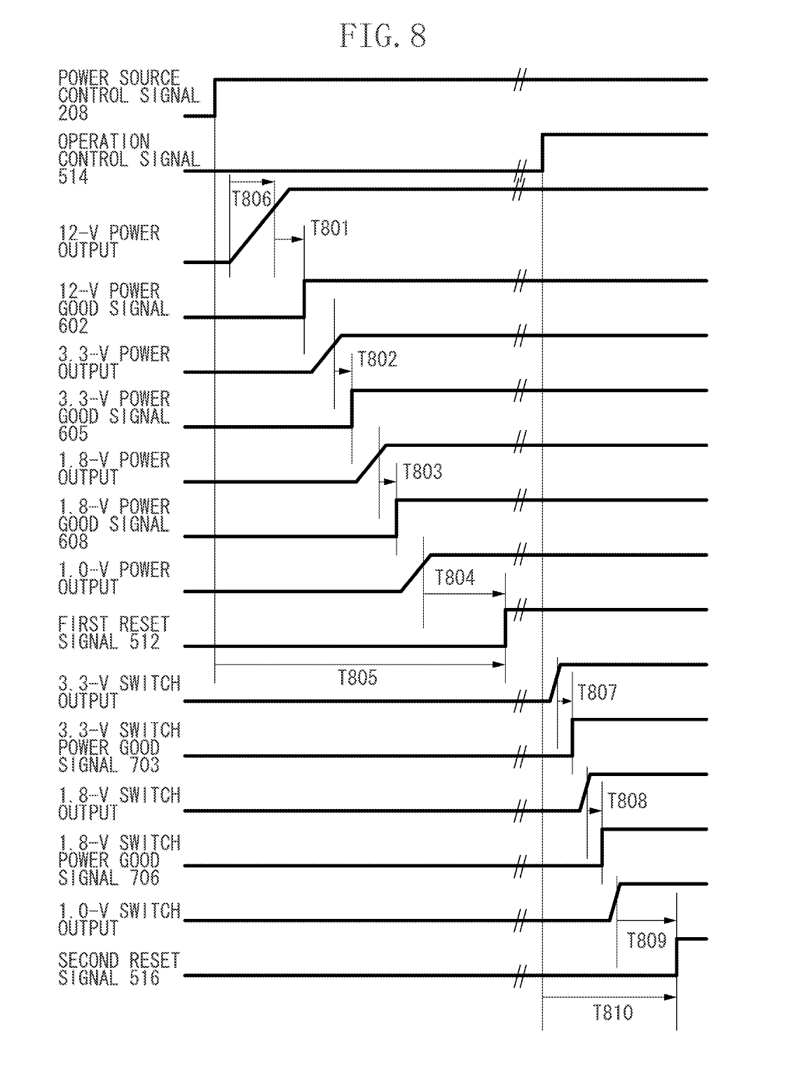

FIG. 8 is a timing chart illustrating an example operation of the switch unit 515 illustrated in FIG. 7. This example indicates waveforms of power outputs and control signals when starting power supply according to the first exemplary embodiment. The power source control signal 208 is a high active signal which means power ON in the high-level state, and means power OFF in the low-level state. The local power source unit 510 according to the present exemplary embodiment sequentially determines generation of power having different power levels, and generates power having a plurality of power levels, in response to determination to generate power having one power level at the timing described below.

The first reset signal 512 is a low active signal which resets the circuit in the low-level state, and activates the circuit in the high-level state. The 12-V power good signal 602, the 3.3-V power good signal 605, and the 1.8-V power good signal 608 are high active signals which mean power output in the high-level state, and mean non-power output or an output voltage lower than the prescribed value in the low-level state.

As described above, when the power source control signal 208 is asserted, 12-V power is output from the second power source 207. When a delay time T801 has elapsed since a certain voltage is reached, the 12-V power good signal 602 is asserted. Hereinafter, the 3.3-V power good signal 605 provides a delay time T802, the 1.8-V power good signal 608 provides a delay time T803, and the 1.0-V power output provides a delay time T804.

To initialize an internal clock of the CPU 502 and each circuit, the delay time T804 needs to be longer than the delay time T802 and the delay time T803. A wait time T806 necessary for the voltage of the second power source 207 to rise is longer than that for other power outputs. There are many portions to which the second power source 207 can supply power, resulting in a large load. Therefore, if the voltage of the second power source 207 quickly rises, an inrush current increases and activation processing fails.

A total time period T805 indicates a time period since the power source control signal 208 is asserted until the first reset signal 512 is asserted. The total time period T805 is a part of operations of the MFP 104 for returning from the energy-saving mode. Shortening the total time period T805 enables reducing user's stress for waiting for activation.

The output of each switch is prevented until the operation control signal 514 is asserted. After the operation control signal 514 is asserted, the 3.3-V switch unit 701, the 1.8-V switch unit 704, and the 1.0-V switch unit 707 are sequentially connected in this order. Referring to FIG. 8, respective power good signals provide delay times T807, T808, and T809. A time period T810 since the operation control signal 514 is asserted until the second reset signal 516 is asserted can be made shorter than the total time period T805. The return time is shortened by the difference between the time period T810 and the total time period T805, in comparison with a conventional case in which power supply does not start through human body detection.

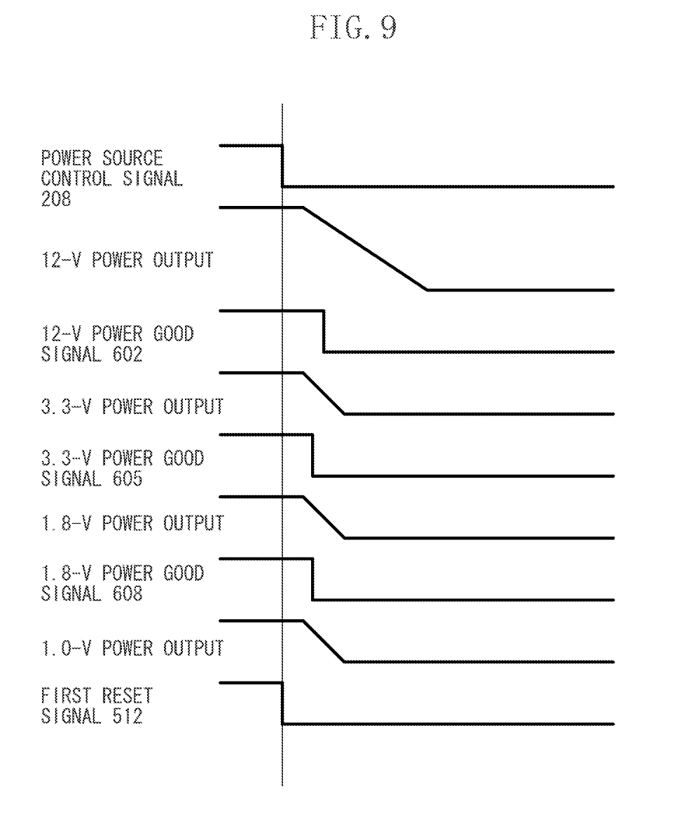

FIG. 9 is a timing chart illustrating power outputs and control signals when the image forming apparatus according to the present exemplary embodiment shifts to the energy-saving mode.

When the image forming apparatus shifts to the energy-saving mode, the CPU 502 determines shift conditions, shuts down the system when shift conditions are satisfied, and, when shutdown is completed, asserts a shutdown request signal 513. At this timing, the starting trigger generation unit 509 negates the power source control signal 208. Then, the starting signal of the power generation circuit of the local power source unit 510 is negated, and each power output turns OFF. Further, the first reset signal 512 is also negated.

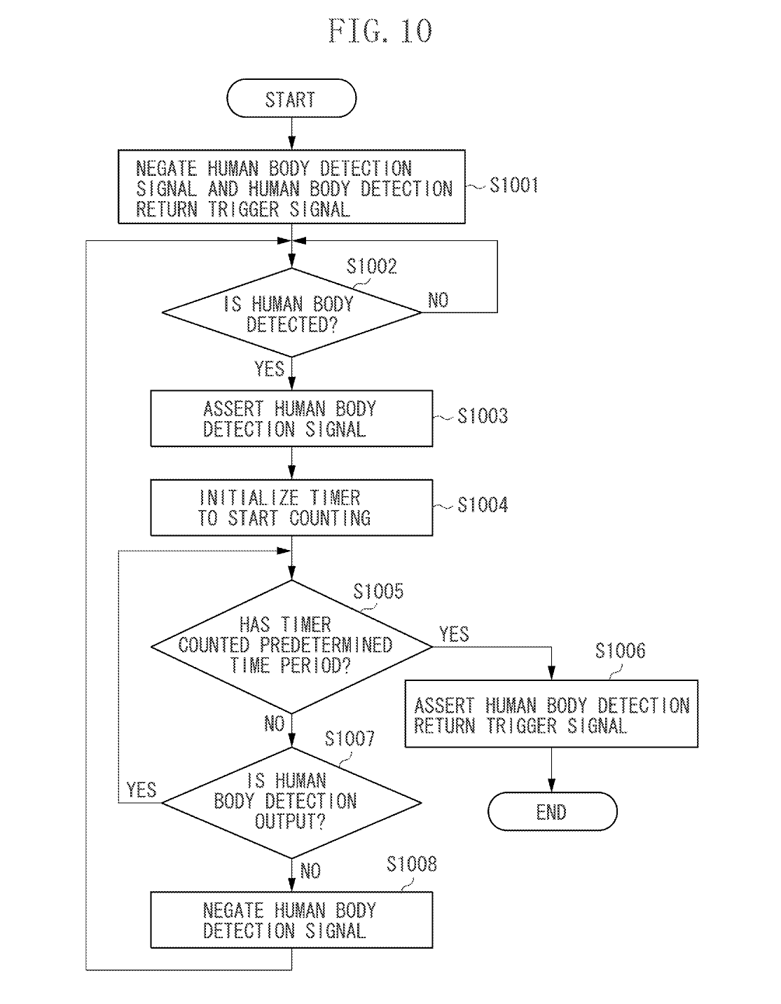

FIG. 10 is a flowchart illustrating a method for controlling the image forming apparatus according to the present exemplary embodiment. This example indicates processing by the human body detection unit 210 illustrated in FIG. 2. Each step is implemented when the human body detection control unit 402 illustrated in FIG. 4 executes a control program stored in the internal memory. Hereinafter, when the human body detection unit 210 changes to a first state where an object (the body of the user operating the image forming apparatus) is detected, the human body detection control unit 402 controls a power generation unit for shifting from the second power state to the first power state to start power generation. The following describes example processing for restricting supplying the power generated by the power generation unit to the control unit 202 when the human body detection unit 210 changes from the first state where an object is detected to a second state where no object is detected.

In step S1001, the human body detection control unit 402 negates the human body detection signal 211 and the human body detection return trigger signal 212. In step S1002, the human body detection control unit 402 waits until the human body detection sensor 209 detects a human body (object). When the human body is determined to have been detected (YES in step S1002), then in step S1003, the human body detection control unit 402 asserts the human body detection signal 211. As described above, when the human body detection control unit 402 asserts the human body detection signal 211, the starting trigger generation unit 509 asserts the power source control signal 208, and the second power source 207 starts power output. In step S1004, the CPU 502 of the control unit 202 initializes an internal timer (not illustrated) for reducing false detection to start count processing.

In step S1005, the CPU 502 of the control unit 202 determines whether the timer which started the above-described count processing has counted a predetermined time period. When the CPU 502 determines that the predetermined time period has been counted (YES in step S1005), it determines that the human body detected by the human body detection sensor 209 is a user who intends to operate the MFP 104, and the processing proceeds to step S1006.

In step S1006, to return the image forming apparatus from the energy-saving mode (low power state), the CPU 502 of the control unit 202 asserts the human body detection return trigger signal 212, and ends the processing for returning to the normal power state.

On the other hand, when the CPU 502 determines that the predetermined time period has not been counted (NO in step S1005), then in step S1007, the CPU 502 determines whether human body detection is output from the human body detection sensor 209. When the CPU 502 determines that human body detection is output (YES in step S1007), it repeats the processing from step S1005. On the other hand, when the CPU 502 determines human body detection is not output (NO in step S1007), it determines that the object is a passer-by who passes the image forming apparatus, then in step S1008, the CPU 502 negates the human body detection signal 211. At this timing, the starting trigger generation unit 509 negates the power source control signal 208 to turn OFF the second power source 207 and the local power source unit 510. Then, the CPU 502 returns processing to step S1002, and waits for human body detection.

According to the present exemplary embodiment, the switch unit 515 is provided between the local power source unit 510 and the CPU 502. Using the human body detection signal 211 and the human body detection return trigger signal 212 enables quickly returning from the energy-saving mode.

Even in a case of false human body detection, the power increase can be reduced, and power supply can be immediately turned OFF at the timing when false detection is determined. Further, even in a state where power supply is turned ON, the power consumption slightly increases since there is no power load.

Although, in the present exemplary embodiment, each switch is turned ON when the relevant human body detection return trigger is asserted, the same effect can be obtained even when a DC/DC voltage conversion circuit is used instead of a switch. When the DC/DC voltage conversion circuit is used, for example, the local power source unit 510 described in the first exemplary embodiment is not necessary, and the output of the second power source 207 is connected to the input of the DC/DC voltage conversion circuit.

When a trigger input other than human body detection, for example, a network return trigger signal 311, is asserted, the image forming apparatus can be returned from the sleep state by simultaneously asserting the power source control signal 208 and the operation control signal 514.

The present exemplary embodiment is also applicable to return triggers other than human body detection, for example, a return from the energy-saving mode upon reception of a network packet. In the case of network packet reception, for example, control is performed in such a way that power supply is turned ON upon reception of a packet, and the switch unit 515 is turned ON when the network I/F unit 501 determines that power supply should start based on the contents of the packet.

Different sensors may be used for a first trigger and a second trigger. For example, as described in “Description of Related Art”, it is also applicable to an example in which a pyroelectric sensor and a reflection type sensor are used together to detect a human body. A pyroelectric sensor is used as the first trigger, and a reflection type sensor as the second trigger.

A second exemplary embodiment will be described below based on an example in which the power increase is reduced by deactivating each circuit by asserting the reset signal even in a case where power is supplied to each circuit of the control unit 202. In the present exemplary embodiment, after a predetermined time period has elapsed since the human body detection sensor 209 detected an object, if the MFP 104 shifts to a state where the object is not detected, the MFP 104 resets the control unit 202 and performs power source control for shifting to a third power state while continuing power generation processing.

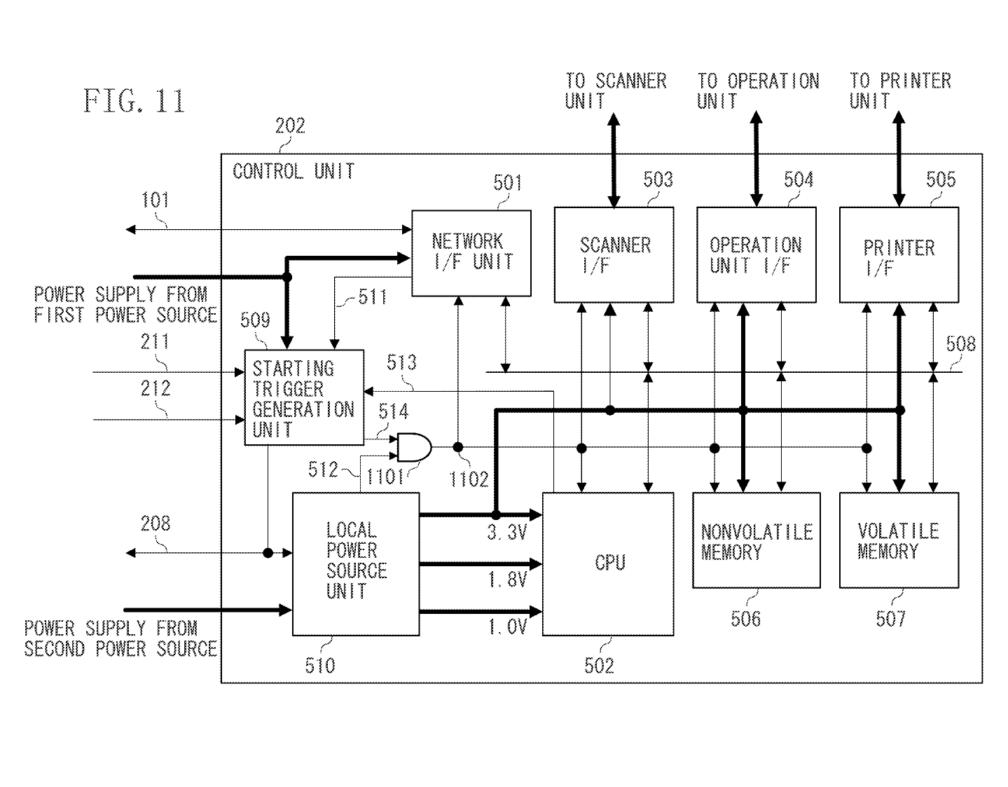

FIG. 11 is a block diagram illustrating a configuration of the image forming apparatus according to the present exemplary embodiment. This example corresponds to another example configuration of the control unit 202. The configuration of the present exemplary embodiment differs from that of the first exemplary embodiment in that a reset generation circuit 1101 is provided instead of the switch unit 515.

Referring to FIG. 11, the reset generation circuit 1101 is an AND circuit for the operation control signal 514 (described in the first exemplary embodiment) and the first reset signal 512 output by the local power source unit 510. The reset generation circuit 1101 generates a third reset signal 1102 which is input to each circuit of the control unit 202 as a reset signal.

The above-described configuration enables performing control in such a way that power supply to each circuit starts after the power source control signal 208 is asserted, and, if the operation control signal 514 is not asserted after the first reset signal 512 is negated, the third reset signal 1102 is not negated. Specifically, since each circuit of the control unit 202 does not operate, the control unit 202 consumes less power than it does during operation. Then, when the operation control signal 514 is negated, the third reset signal 1102 is negated, and the control unit 202 immediately starts operation.

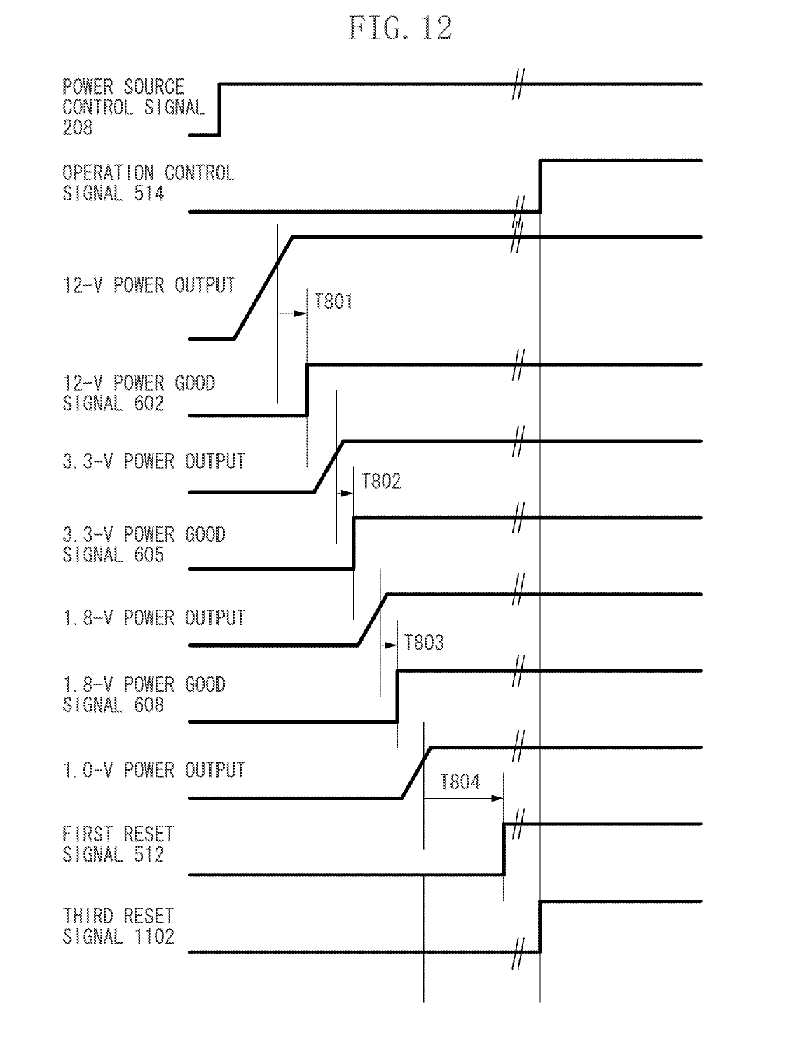

FIG. 12 is a timing chart illustrating operations of the image forming apparatus illustrated in FIG. 11. This example corresponds to the timing of power outputs and control signals when the image forming apparatus shifts to the energy-saving mode. As illustrated in FIG. 11, the third reset signal 1102 is the logical product (AND) of the operation control signal 514 and the first reset signal 512. Since the third reset signal 1102 is negated at the same time when the operation control signal 514 is negated, the starting time can be zeroed.

According to the present exemplary embodiment, the power increase can be reduced by deactivating each circuit by asserting each reset signal even in a case where power is supplied to each circuit of the control unit 202. Since the time required to start power supply can be zeroed, the present exemplary embodiment provides more profound effect of quickly returning from the sleep time than that in the first exemplary embodiment.

Although, in the second exemplary embodiment, a reset signal is used as a signal for deactivating operations of each circuit in a state where power is supplied to each circuit of the control unit 202, other signals, for example, a signal for stopping the clock may be used.

Therefore, according to each exemplary embodiment, even if power generation starts upon detection of a factor on which the second power state should be canceled, the power generation processing can be restricted if the factor on which the second power state should be canceled is not maintained. Further, even if power generation starts upon detection of the factor on which the second power state should be canceled, the power-saving state can be continued by keeping preventing the control unit 202 from starting control processing.

Each process of the embodiments can also be implemented when software (program) acquired via a network or various storage media is executed by a processing apparatus (a CPU or a processor) in a PC (computer).

The disclosure is not limited to the above-described exemplary embodiments, and can be modified in diverse ways (including organic combinations of these exemplary embodiments) without departing from the spirit and scope thereof. These modifications are not excluded from the scope of the disclosure.

According to the disclosure, even power generation starts upon detection of a factor on which the second power state should be canceled, the power generation processing can be restricted if the factor on which the second power state should be canceled is not maintained.

Embodiments of the disclosure can also be realized by a computer of a system or apparatus that reads out and executes computer executable instructions recorded on a storage medium (e.g., non-transitory computer-readable storage medium) to perform the functions of one or more of the above-described embodiment(s) of the disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2013-200060 filed Sep. 26, 2013, which is hereby incorporated by reference herein in its entirety.

What is claimed is:

1. An information processing apparatus comprising:
a first control unit;
a first detection unit configured to detect a person;
a generation unit configured to generate power to be supplied to the control unit when a person is detected by the first detection unit;
a determination unit configured to determine whether the person detected by the first detection unit is a user of the information processing apparatus; and
a second control unit configured to, when the determination unit determines that the person detected by the first detection unit is a user of the information processing apparatus, perform control to supply the power generated by the generation unit to the first control unit.

2. The information processing apparatus according to claim 1, wherein, when the determination unit determines that the person detected by the first detection unit is not a user of the information processing apparatus, the second control unit performs control so that the generation unit does not generate the power.

3. The information processing apparatus according to claim 1, wherein, when the first detection unit continuously detects a person for a predetermined time period, the determination unit determines that the person detected by the first detection unit is a user of the information processing apparatus.

4. The information processing apparatus according to claim 1, further comprising a printing unit configured to execute print processing,
wherein the generation unit generates power to be supplied to the printing unit.

5. The information processing apparatus according to claim 1, wherein the first detection unit is a sensor for receiving an infrared ray.

6. The information processing apparatus according to claim 1, further comprising:
a second detection unit having a detection range narrower than that of the first detection unit,
wherein, when the second detection unit detects a person, the determination unit determines that the person detected by the first detection unit is a user of the information processing apparatus.

7. A method for controlling an information processing apparatus comprising a control unit configured to control the information processing apparatus, and a detection unit configured to detect a person, the method comprising:
generating, when the detection unit detects a person, power to be supplied to the control unit;
determining whether the person detected by the detection unit is a user of the information processing apparatus; and
performing, when the person detected by the detection unit is determined to be a user of the information processing apparatus, control to supply the generated power to the control unit.
